(19) United States
(12) Patent Application Publication
(10) Pub. No.: US 2006/0273621 A1
(43) Pub. Date: Dec. 7, 2006

(54) Lift-off door hinge

(75) Inventors: David Shaw, Richmond Hill (CA); Joaquin Hung, Markham (CA); Brad F. Patzer, Barrie (CA); Dave Labey, Newmarket (CA)

Correspondence Address: PILLSBURY WINTHROP SHAW PITTMAN, LLP, P.O. BOX 10500, MCLEAN, VA, 22102, US

(73) Assignee: Ventra Group, Inc., Bradford (CA)

(21) Appl. No.: 11/144,785

(22) Filed: Jun. 6, 2005

(51) Int. Cl. B60J 5/00

(52) U.S. Cl. 296/146.11

(57) ABSTRACT

A separable, lift-off hinge for a vehicle door includes two separable brackets. Bushings mount to one of the brackets. Pins pivotally connect to the bushings to define the pivotal connection of the hinge. The pins removably mate with openings in the other bracket so that the brackets may be attached to each other and detached from each other by moving the brackets axially relative to each other. The pins and openings have complimentary non-circular cross-sections that prevent the pins from pivoting relative to the openings when the brackets are connected to each other. A fastener removably attaches to one of the pins to keep the brackets operatively connected to each other.

### BACKGROUND OF THE INVENTION

1. Field of the Invention

This invention relates to separable hinges for attaching vehicle doors to vehicles.

2. Description of Related Art

In the automotive industry, it is known to attach a vehicle door to a vehicle using a separable hinge. Such a separable hinge facilitates the convenient attachment and detachment of the door from the vehicle. Such separability is advantageous for various reasons, e.g., to facilitate post-painting detachment/reattachment of the door to the vehicle, to facilitate installation or replacement of a door, etc.

One conventional separable hinge is a lift-off door hinge. For example, U.S. Pat. No. 4,766,643 discloses a lift-off door hinge in which bearings/bushings disposed on one side of the hinge have openings therein that detachably mate with corresponding pivot pins on the other side of the hinge. The hinge's pivotal joint is defined between the bushings and pivot pins, which pivot relative to each other. Because this pivotal connection also defines the point of separability of the two hinge sides, there must be sufficient clearance between the holes in the bushings and the pivot pins to facilitate the mating and detachment of these components. Such clearance increases the amount of “play” in the hinge. Further, the clearance results in increased wear on the pivot pins and bushings. Furthermore, insertion of the pivot pins into the bushings during attachment and/or detachment may damage the bushings.

### SUMMARY OF THE INVENTION

Accordingly, one aspect of one or more embodiments of this invention provides a separable hinge for a vehicle door that reduces the likelihood that the hinge will be damaged during separation and/or attachment of the hinge halves.

Another aspect of one or more embodiments of this invention provides a separable hinge for a vehicle door that reduces “play” in the hinge.

Another aspect of one or more embodiments of this invention provides a vehicle that includes a vehicle body, a vehicle door, and a vehicle door hinge detachably and pivotally connecting the vehicle door to the vehicle body. The hinge includes a first bracket operatively connected to one of the vehicle body and vehicle door. The first bracket includes a first bushing mounted thereto. The first bushing has an internal opening. The first bracket also includes a first pin pivotally received within the internal opening of the first bushing to allow relative pivotal movement of the first bushing and the first pin relative to one another about a pivot axis. The hinge also includes a second bracket operatively connected to the other of the vehicle body and vehicle door. The hinge further includes a first opening disposed on the second bracket. The first pin has an engaging portion removably received in the first opening such that pivotal movement between the first pin and the second bracket is prevented. The pivotal movement allowed between the first bushing and the first pin enables the first and second brackets to pivot relative to one another about the pivot axis. The vehicle door can be disconnected from the vehicle body by moving the vehicle door so as to move the first and second brackets relative to one another and disengage the first pin and the first opening.

According to a further aspect of one or more of these embodiments, the first and second brackets may be separated from each other by moving the brackets relative to each other along the pivot axis so as to remove the first pin from the first opening.

The hinge may further include a fastener that removably connects to the first pin to prevent the first pin from separating from the first opening. The fastener may be an externally threaded bolt that mates with an internally threaded bore in the first pin. Alternatively, the fastener may be an internally threaded nut that mates with an externally threaded portion of the first pin.

According to a further aspect of one or more of these embodiments, the engaging portion of the first pin that extends into the first opening has a non-circular cross-section, and a portion of the first opening that receives the portion of the first pin has a complimentary non-circular cross-section. The cross-sections of these portions may be hexagonal.

According to a further aspect of one or more of these embodiments, the first bracket has a mounting part operatively connected to the one of the vehicle body and the vehicle door, and a first arm extending from the mounting part thereof. The second bracket has a mounting part operatively connected to the other of the vehicle body and the vehicle door, and a first arm extending from the mounting part thereof. The first bushing and the first pin are on the first arm of the first bracket, and the first opening is on the first arm of the second bracket.

According to a further aspect of one or more of these embodiments, the first bracket includes a second arm spaced apart from the first arm thereof and extending from the mounting part thereof. The second bracket includes a second arm spaced apart from the first arm thereof and extending from the mounting part thereof. One of the second arms includes (a) a second bushing mounted thereto and having an internal opening, and (b) a second pin. The second pin and the second bushing are coaxial with the pivot axis. The second pin is pivotally received within the internal opening of the second bushing to allow pivotal movement of the second bushing and the second pin relative to one another. The other of the second arms includes a second opening. The second pin has an engaging portion removably received in the second opening such that pivotal movement between the second pin and the other of the second arms is prevented. The vehicle door can be disconnected from the vehicle body by moving the vehicle door so as to move the first and second brackets relative to one another and disengage the first and second pins from the first and second openings.

According to a further aspect of one or more of these embodiments, the second pin is shaped to help align the second pin with the second opening during attachment of the second pin to the second opening. The second pin may include a pointed or rounded tip.

According to a further aspect of one or more of these embodiments, the first and second brackets may be separated from each other without separating the first pin from the first bushing.

Another aspect of one or more embodiments of this invention provides a lift-off vehicle door hinge for use in connection with the above-described vehicle.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a perspective view of a lift-off vehicle door hinge in a separated state according to an embodiment of the present invention;

FIG. 2 is a perspective view of the lift-off vehicle door hinge in FIG. 1, shown in an attached state;

FIG. 3 is a partial cross-sectional view of the lift-off vehicle door hinge in FIG. 2, taken along the line 3-3 in FIG. 2;

FIG. 4 is a perspective view of a lift-off vehicle door hinge according to an alternative embodiment of the present invention; and

FIG. 5 is a partial cross-sectional view of the lift-off vehicle door hinge in FIG. 4.

### DETAILED DESCRIPTION OF PREFERRED EMBODIMENTS

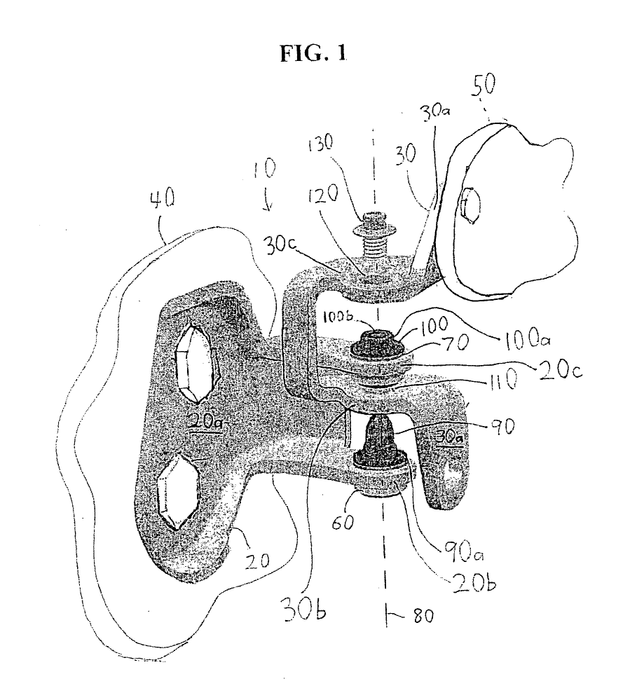

FIGS. 1-3 illustrate a lift-off vehicle door hinge 10 according to an embodiment of the present invention.

As shown in FIG. 1, the hinge 10 includes a body-side bracket 20, a door-side bracket 30, two bushings 60, 70, two pins 90, 100, two openings 110, 120, and a locking fastener 130.

As shown in FIG. 1, the brackets 20, 30 include mounting parts 20a, 30a, lower arms 20b, 30b extending from the mounting parts 20a, 30a, respectively, and upper arms 20c, 30c extending from the mounting parts 20a, 30a, respectively. The arms 20b, 20c are spaced apart from one another relative to a pivot axis 80. The arms 30b, 30c are spaced apart from one another relative to the pivot axis 80. The mounting parts 20a, 30a are operatively connected to a vehicle body 40 and vehicle door 50, respectively, of a vehicle via any suitable mechanism (e.g., bolts, welding, integral formation, glue, screws, etc.). The vehicle may be any type of vehicle onto which a pivotal door may be attached (e.g., automobile, tractor, farm machinery, etc.). While only one hinge 10 is illustrated, two hinges 10 are preferably used to mount each vehicle door 50 to the vehicle body 40.

The bushings 60, 70 mount to openings in the arms 20b, 20c, respectively, of the bracket 20 such that the bushings are coaxial and axially spaced from each other relative to a pivot axis 80. The bushings 60, 70 may be any type of bushings (e.g., ball bearings, solid metal or plastic bushings, two-piece bushings (i.e., a bushing having separable upper and lower axial halves), etc.).

Lower and upper pivot pins 90, 100 are pivotally received in internal openings of the bushings 60, 70, respectively, to define a pivotal connection of the hinge 10. The pivot pins 90, 100 pivot relative to the bushings 60, 70 (relative to just the outside portions of the bushings 60, 70 if the bushings are multi-piece bearings). In the illustrated embodiment, the pins 90, 100 comprise rivets 90, 100 or swaged portions that fasten to the bushings 60, 70 to keep the bushings 60, 70 in place in the bracket 20 and to keep the pins 90, 100 attached to the bushings 60, 70. As can be seen from the figures, these rivets prevent axial movement of the pins 90, 100 relative to the bushings 60, 70. As shown in FIG. 3, lower ends of the pins 90, 100 may be expanded to secure the pins 90, 100 to the bushings 60, 70. Washers 140 may be positioned axially between the pins 90, 100 and the bushings 60, 70 to prevent damage to the bushings 60, 70 during riveting/expansion. The pins 90, 100 could alternatively comprise any other type of suitable pins (e.g., partially threaded bolts/nuts, pins with mating cotter pins, etc.) without deviating from the scope of the present invention. The pins 90, 100 are aligned with the pivot axis 80.

As shown in FIG. 3, each bushing 60, 70 has lower and upper radially-extending flanges 60a, 60b, 70a, 70b that abut upper and lower surfaces on the arms 20b, 20c. The flanges 60a, 60b, 70a, 70b may be used to secure the bushings 60, 70 to the arms 20a, 20b. The pins 90, 100 also have lower and upper radially-extending flanges 90c, 90d, 100c, 100d. The flanges 90c, 90d on the pin 90 abut the flanges 60a, 60b, respectively, on the bushing 60 to secure the pin 90 to the bushing 60 and the arm 20b. Similarly, the flanges 100c, 100d on the pin 100 abut the flanges 70a, 70b on the bushing 70 to secure the pin 100 to the bushing 70. Abutment between the flanges 90c, 90d, 100c, 100d and flanges 60a, 60b, 70a, 70b may be direct or indirect (e.g., via washers 140, thrust bearings, etc.). When the bracket 30 is attached to the bracket 20, lower surfaces of the arms 30b, 30c abut upper surfaces of the flanges 90d, 100d such that the flanges 90d, 100d vertically support the bracket 30. Any one or more of the flanges 60a, 60b, 70a, 70b, 90c, 90d, 100c, 100d may be omitted without deviating from the scope of the present invention.

The illustrated pins 90, 100 preferably comprise a strong metal such as steel. However, any other suitable material or composite of materials could alternatively be used without deviating from the scope of the present invention. Indeed, distinct portions of the pins 90, 100 could comprise distinct materials that are fastened or otherwise connected to each other to create the pins 90, 100.

As shown in FIG. 1, the pins 90, 100 each include upwardly extending engaging portions 90a, 100a that are adapted to be removably received in corresponding locating openings 110, 120 in the arms 30b, 30c, respectively, of the bracket 30. As shown in FIG. 1, the openings 110, 120 and portions 90a, 100a have complimentary, mating, non-circular cross-sections. In the illustrated embodiment, the pin portions 90a, 100a and openings 110, 120 have hexagonal cross-sections, but may alternatively have any other cross-section (e.g., oval, polygon, etc.) without deviating from the scope of the present invention. Such non-circular cross-sections prevent relative pivotal movement between the pins 90, 100 and the openings 110, 120, and thereby reduce the possible squeaks that can result from relative movement between such parts.

The portions 90a, 100a and openings 110, 120 are preferably shaped to correctly mate with each other even when initially misaligned. If one of the portions 90a, 100a is misaligned with its corresponding opening 110, 120 during assembly, the misaligned pin 90, 100 will tend to rotate to correct the misalignment during assembly. A curved surface disposed between adjacent faces of the hexagonal cross-section on the portions 90a, 100a may facilitate this corrective rotation.

The pin portions 90a, 100a and openings 110, 120 may even have circular cross-sections that would allow relative pivotal movement, though non-circular cross-sections are preferred.

The illustrated openings 110, 120 comprise openings that are stamped, drilled, machined, or otherwise formed in the bracket 30. The openings 110, 120 may alternatively be otherwise disposed on the bracket 30 without deviating from the scope of the present invention. Similarly, while the illustrated openings 110, 120 comprise closed-perimeter holes, the openings 110, 120 could alternatively comprise other shapes/configurations (e.g., open-sided slots formed in an edge of the bracket 30) without deviating from the scope of the present invention.

Because the pins 90, 100 and openings 110, 120 need not pivot relative to each other, these components can be formed with an interference fit that further discourages relative movement between the pins 90, 100 and openings 110, 120. Moreover, because pivotal movement of the hinge 10 does not depend on the dimensional tolerances between the pins 90, 100 and the openings 110, 120, the pins 90, 100 and openings 110, 120 may be manufactured inexpensively using higher dimensional tolerances.

As shown in FIG. 1, the lower pin 90 has a generally pointed (e.g., conical, bullet-shaped, etc.) tip that is shaped to help axially align the lower pin 90 with the opening 110 during attachment of the lower pin 90 (and bracket 30) to the opening 110 (and bracket 20).

As shown in FIGS. 1 and 3, a locking fastener 130 fastens to the upper pin 100 to prevent the upper pin 100 (and the bracket 20) from disengaging from the opening 120 (and bracket 30). The illustrated locking fastener 130 comprises a bolt that mates with a internally-threaded bore 100b in the upper end of the upper pin 100. The fastener 130 prevents the bracket 30 from moving axially upwardly relative to the bracket 20 and disengaging from the bracket 20. The fastener 130 and bore 100b are axially aligned with the pivot axis 80.

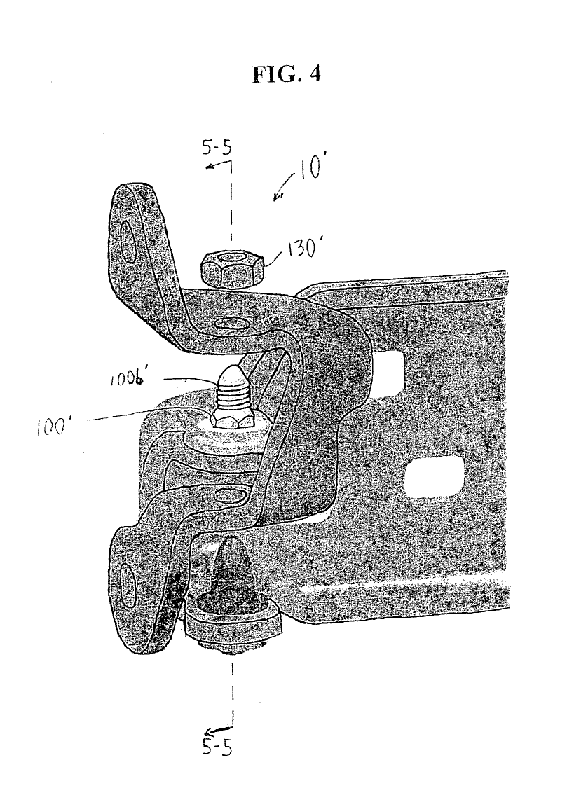

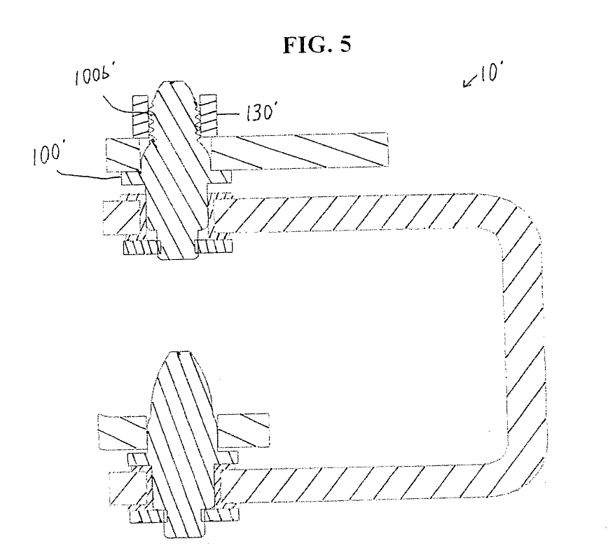

The fastener 130 may alternatively comprise any other fastener suited to prevent the brackets 20, 30 from disengaging from each other via relative axial movement along the axis 80. For example, FIGS. 4 and 5 illustrate a hinge 10′ according to an alternative embodiment of the present invention. The hinge 10′ is generally similar to the hinge 10, except that a fastener 130′ comprises a nut instead of a bolt and removably engages an externally threaded portion 100b′ of an upper pin 100′ instead of an internally threaded bore. The fastener 130 may alternatively comprise any other suitable fastener as would be understood by one of ordinary skill in the art (e.g., screw, C-clip, cotter pin, E-ring, etc.). The pin may similarly include any suitable feature for mating with the fastener (e.g., an internally threaded axial bore, external axial threads, an annular groove, a radial bore, etc.).

While the illustrated fasteners 130, 130′ fasten directly to a pin 100, 100′, a fastener could alternatively fasten to any other suitable structure on the brackets 20, 30, vehicle body 40, door 50, etc., so long as the fastening of the fastener prevents the brackets 20, 30 from separating from each other.

While both bushings 60, 70 and pins 90, 100 are disposed on the body-side bracket 20 and both openings 110, 120 are disposed on the door-side bracket 30 in the illustrated embodiment, the bushings 60, 70 and pins 90, 100 may alternatively be disposed on the door-side bracket 30 and the openings 110, 120 may be disposed on the body-side bracket 20 without deviating from the scope of the present invention. In such an alternative embodiment, the pins 90, 100 would preferably extend downwardly from the door-side bracket 30 such that the bracket 30 is moved upwardly relative to the body-side bracket 20 to lift the bracket 30 and door 50 off of the bracket 20.

Furthermore, one of the pins 90, 100 and one of the openings 110, 120 may be disposed on each bracket 20, 30 in a manner similar to that shown in FIG. 3 of U.S. Pat. No. 4,766,643, which is hereby incorporated by reference. In such an embodiment, the pin 90, 100 disposed on the door-side bracket 30 preferably extends downwardly while the pin 90, 100 disposed on the body-side bracket 20 preferably extends upwardly.

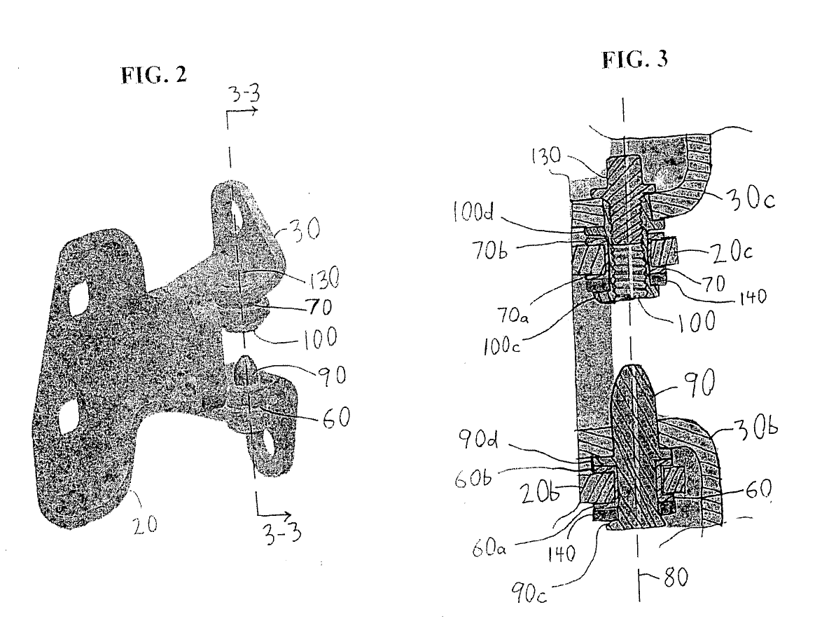

Hereinafter, separation and reassembly of the hinge 10 is described with reference to FIG. 1. To attach the separated brackets 20, 30 to each other, the pins 90, 100 are first axially aligned with the openings 110, 120 along the pivot axis 80. The bracket 30 is then lowered onto the bracket 20 in the direction of the axis 80 such that the pins 90, 100 extend into the openings 110, 120. The rounded shape of the tip of the lower pin 90 helps to align the pin 90 with the opening 110. The complimentary hexagonal cross-sections of the pin portions 90a, 100a and openings 110, 120 mate with each other to prevent the pins 90, 100 from pivoting relative to the openings 110, 120. Once the bracket 30 has been lowered onto the bracket 20, the fastener 130 is attached to the upper pin 100 to prevent the brackets 20, 30 from inadvertently axially separating from each other. The assembled hinge 10 is shown in FIG. 2. Separation of the brackets 20, 30 of the hinge 10 is achieved by reversing the above-described assembly steps.

Because assembly and disassembly of the hinge brackets 20, 30 does not require separation and attachment of the pins 90, 100 from their respective bushings 60, 70, the pivotal connection defined between the pins 90, 100 and bushings 60, 70 can be made with a tight tolerance that results in less play in the hinge. Keeping the pins 90, 100 connected to the bushings 60, 70 also helps to prevent damage to the bushings, which could otherwise occur if the pins had to be inserted into the bushings during assembly and disassembly of the hinge 10.

The hinge 10 includes discrete structures for achieving the separability feature (separable connection between the pins 90, 100 to openings 110, 120) and the pivotability feature (sustained pivotal connection between the pins 90, 100 and the bushings 60, 70) of the hinge 10. The design (e.g., sizes, materials, tolerances) of the structures that facilitate separability in the hinge 10 can therefore be optimized without affecting the discrete structures that create the pivotal connection of the hinge 10, and vice versa.

While the illustrated hinge 10 is used to pivotally connect a vehicle door to a vehicle body, the hinge 10 could alternatively be used to pivotally connect any other two components where separability of the hinge would be advantageous. The hinge 10 is particularly well suited for applications in which one of the components can be lifted off of the other component to separate the hinge.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A vehicle comprising:
a vehicle body;
a vehicle door; and
a vehicle door hinge detachably and pivotally connecting the vehicle door to the vehicle body, the hinge comprising
a first bracket operatively connected to one of the vehicle body and vehicle door, the first bracket including a first bushing mounted thereto, the first bushing having an internal opening, the first bracket also including a first pin pivotally received within the internal opening of the first bushing to allow relative pivotal movement of the first bushing and the first pin relative to one another about a pivot axis,
a second bracket operatively connected to the other of the vehicle body and vehicle door, and
a first opening disposed on the second bracket, wherein the first pin has an engaging portion removably received in the first opening such that pivotal movement between the first pin and the second bracket is prevented,
wherein the pivotal movement allowed between the first bushing and the first pin enables the first and second brackets to pivot relative to one another about the pivot axis, and
wherein the vehicle door can be disconnected from the vehicle body by moving the vehicle door so as to move the first and second brackets relative to one another and disengage the first pin and the first opening.

2. The vehicle of claim 1, wherein the first and second brackets may be separated from each other by moving the brackets relative to each other along the pivot axis so as to remove the first pin from the first opening.

3. The vehicle of claim 2, further comprising a fastener that removably connects to the first pin to prevent the first pin from separating from the first opening.

4. The vehicle of claim 3, wherein the first pin includes an externally threaded portion, and wherein the fastener includes an internally threaded bore that mates with the externally threaded portion of the first pin.

5. The vehicle of claim 1, wherein the engaging portion of the first pin that extends into the first opening has a non-circular cross-section, and wherein a portion of the first opening that receives the portion of the first pin has a complimentary non-circular cross-section.

6. The vehicle of claim 5, wherein the engaging portion of the first pin has a hexagonal cross-section, and wherein the portion of the first opening has a hexagonal cross-section.

7. The vehicle of claim 1, wherein:
the first bracket has a mounting part operatively connected to the one of the vehicle body and the vehicle door, and a first arm extending from the mounting part thereof;
the second bracket has a mounting part operatively connected to the other of the vehicle body and the vehicle door, and a first arm extending from the mounting part thereof; and
the first bushing and the first pin are on the first arm of the first bracket, and the first opening is on the first arm of the second bracket.

8. The vehicle of claim 7, wherein:
the first bracket includes a second arm spaced apart from the first arm thereof and extending from the mounting part thereof;
the second bracket includes a second arm spaced apart from the first arm thereof and extending from the mounting part thereof;
one of the second arms includes (a) a second bushing mounted thereto and having an internal opening, and (b) a second pin, the second pin and the second bushing being coaxial with the pivot axis, the second pin being pivotally received within the internal opening of the second bushing to allow pivotal movement of the second bushing and the second pin relative to one another;
the other of the second arms includes a second opening;
the second pin has an engaging portion removably received in the second opening such that pivotal movement between the second pin and the other of the second arms is prevented; and
the vehicle door can be disconnected from the vehicle body by moving the vehicle door so as to move the first and second brackets relative to one another and disengage the first and second pins from the first and second openings.

9. The vehicle of claim 8, wherein the second pin is shaped to help align the second pin with the second opening during attachment of the second pin to the second opening.

10. The vehicle of claim 9, wherein the second pin has a pointed tip that helps align the second pin with the second opening during attachment of the second pin to the second opening.

11. The vehicle of claim 1, wherein the first and second brackets may be separated from each other without separating the first pin from the first bushing.

12. A vehicle comprising:
a vehicle body;
a vehicle door; and
a vehicle door hinge detachably and pivotally connecting the vehicle door to the vehicle body, the hinge comprising
a first bracket operatively connected to one of the vehicle body and vehicle door, the first bracket including a first bushing mounted thereto, the first bushing having an internal opening, the first bracket also including a first pin pivotally received within the internal opening of the first bushing to allow relative pivotal movement of the first bushing and the first pin relative to one another about a pivot axis,
a second bracket operatively connected to the other of the vehicle body and vehicle door,
a first opening disposed on the second bracket, wherein the first pin has an engaging portion removably received in the first opening, and
a fastener that removably connects to the first pin to prevent the first pin from separating from the first opening,
wherein the pivotal movement allowed between the first bushing and the first pin enables the first and second brackets to pivot relative to one another about the pivot axis, and
wherein the vehicle door can be disconnected from the vehicle body by moving the vehicle door along the pivot axis so as to move the first and second brackets relative to one another and disengage the first pin and the first opening.

13. The vehicle of claim 12, wherein the fastener comprises an externally threaded bolt, and wherein the first pin includes an internally threaded bore that mates with the bolt.

14. The vehicle of claim 12, wherein the fastener comprises an internally threaded nut, and wherein the first pin includes an externally threaded portion that mates with the nut.

15. The vehicle of claim 12, wherein:
one of the first and second brackets includes a second bushing mounted thereto, the second bushing having an internal opening;
the one of the first and second brackets includes a second pin pivotally received within the internal opening of the second bushing to allow relative pivotal movement of the second bushing and the second pin relative to one another about the pivot axis;
a second opening is disposed on the other of the first and second brackets; and
the second pin has an engaging portion removably received in the second opening.

16. A hinge for detachably and pivotally connecting a vehicle door to a vehicle body, the hinge comprising:
a first bracket configured to be operatively connected to one of the vehicle body and vehicle door, the first bracket including a first bushing mounted thereto, the first bushing having an internal opening, the first bracket also including a first pin pivotally received within the internal opening of the first bushing to allow relative pivotal movement of the first bushing and the first pin relative to one another about a pivot axis;
a second bracket configured to be operatively connected to the other of the vehicle body and vehicle door; and
a first opening disposed on the second bracket, wherein the first pin has an engaging portion removably received in the first opening such that pivotal movement between the first pin and the second bracket is prevented,
wherein the pivotal movement allowed between the first bushing and the first pin enables the first and second brackets to pivot relative to one another about the pivot axis, and
wherein the brackets can be disconnected from one another by moving the first and second brackets relative to one another so as to disengage the first pin from the first opening.

17. The hinge of claim 16, further comprising a fastener that removably connects to the first pin to prevent the first pin from separating from the first opening.

18. The hinge of claim 17, wherein the fastener comprises an externally threaded bolt, and wherein the first pin includes an internally threaded bore that mates with the bolt.

19. The hinge of claim 16, wherein the engaging portion of the first pin that extends into the first opening has a non-circular cross-section, and wherein a portion of the first opening that receives the portion of the first pin has a complimentary non-circular cross-section.

20. The hinge of claim 16, wherein:
the first bracket has a mounting part configured to be operatively connected to the one of the vehicle body and the vehicle door, and a first arm extending from the mounting part thereof;
the second bracket has a mounting part configured to be operatively connected to the other of the vehicle body and the vehicle door, and a first arm extending from the mounting part thereof; and
the first bushing and the first pin are on the first arm of the first bracket, and the first opening is on the first arm of the second bracket.

21. The hinge of claim 20, wherein:
the first bracket includes a second arm spaced apart from the first arm thereof and extending from the mounting part thereof;
the second bracket includes a second arm spaced apart from the first arm thereof and extending from the mounting part thereof;
one of the second arms includes (a) a second bushing mounted thereto and having an internal opening, and (b) a second pin, the second pin and the second bushing being coaxial with the pivot axis, the second pin being pivotally received within the internal opening of the second bushing to allow pivotal movement of the second bushing and the second pin relative to one another;
the other of the second arms includes a second opening;
the second pin has an engaging portion removably received in the second opening such that pivotal movement between the second pin and the other of the second arms is prevented; and
the brackets can be disconnected from one another by moving the first and second brackets relative to one another so as to disengage the first and second pins from the first and second openings.

22. A hinge for detachably and pivotally connecting a vehicle door to a vehicle body, the hinge comprising:
a first bracket configured to be operatively connected to one of the vehicle body and vehicle door, the first bracket including a first bushing mounted thereto, the first bushing having an internal opening, the first bracket also including a first pin pivotally received within the internal opening of the first bushing to allow relative pivotal movement of the first bushing and the first pin relative to one another about a pivot axis;
a second bracket configured to be operatively connected to the other of the vehicle body and vehicle door;
a first opening disposed on the second bracket, wherein the first pin has an engaging portion removably received in the first opening; and
a fastener that removably connects to the first pin to prevent the first pin from separating from the first opening,
wherein the pivotal movement allowed between the first bushing and the first pin enables the first and second brackets to pivot relative to one another about the pivot axis, and
wherein the brackets can be disconnected from one another by moving the first and second brackets relative to one another so as to disengage the first pin from the first opening.
